(19) United States
(12) Patent Application Publication
(10) Pub. No.: US 2024/0431006 A1
(43) Pub. Date: Dec. 26, 2024

(54) ELECTRONIC CONTROL SYSTEM FOR STREET LIGHTING WITH LED LUMINAIRES

(71) Applicant: David Gui Frederic ALEXANDER KATZ VIGERIE, Ciudad de Mexico (MX)

(72) Inventor: David Gui Frederic ALEXANDER KATZ VIGERIE, Ciudad de Mexico (MX)

(21) Appl. No.: 18/749,710

(22) Filed: Jun. 21, 2024

(30) Foreign Application Priority Data
Jun. 21, 2023 (MX) MX/U/2023/000243

(51) Int. Cl. H05B 47/16; H05B 45/12; H05B 47/19

(52) U.S. Cl. CPC H05B 47/16; H05B 45/12; H05B 47/19

(57) ABSTRACT

An electronic control system to be integrated in drivers, with application in public lighting of LED technology luminaires, for commercial or home use, which controls the switching on, dimming and switching off of the luminaires, at specific times, taking into account the time variations due to season changes throughout the year. With GNSS, GPS, or other geolocator technology, an integrated antenna for satellite reception, a real-time satellite clock, and optional light sensor, which makes it autonomous and capable of following the user-preloaded program. This system does not require the use of external peripherals, such as photocells, NEMA base, modem, control/monitoring center or Internet data network services, which makes it an innovation with greater benefits over current technologies, reducing specific failures by not requiring external accessories and implementation cost, maximizing even more the economic benefit and energy savings.

### BACKGROUND

Nowadays, in cities and roads, public lighting luminaires are used, seeking to improve day by day, obtain greater control and efficiency in their operation through external devices connected to the luminaires, and have communication and control over them, in order to reduce costs and save energy.

Currently there are technologies used such as remote management, adding a wireless internet, radio frequency, etc., communication and control module at the luminaire photocell bases, for controlling and monitoring purposes, linked from a hub to enable this communication and transmit it to a central. This means additional investments in the installation and operation which represent additional hidden costs that are not seen until medium term, so that finally the real benefit is not as expected, resulting in a much higher investment than the cost alone of the simple luminaire.

### SUMMARY OF THE INVENTION

The proposed device to be protected in the present application consists of a programmable electronic control for municipal public lighting using LED luminaires, which allows switching on, dimming and switching off, at different times and levels, following specific schedules and considering the time variations due to the change of seasons throughout the year. By integrating into the DRIVER, with GNSS, GPS, or other geolocator technology, an integrated antenna for satellite reception, a real-time satellite clock, and optional light sensor, which makes it autonomous and capable of following the program preloaded by the user. It does not require the use of external peripherals, such as photocells, NEMA base, modem hubs, any control/monitoring center, or contracted Internet data network services.

It is important to note that this proposed electronic control is not a telemetry or telemanagement system since it only uses the open and unidirectional signal from the geolocation satellites to obtain the time and geographic position. With this information, precise switch-on, dimming and switch-off schedules can be established to maximize street lighting service with LED luminaires, reduce power consumption, and extend luminaires lifetime. The elimination of the need to use photocells, their respective connection base or other LED luminaires turning on and controlling elements, reduces the specific failures in these accessories and the cost of implementation of the systems, thus maximizing the service provided.

Details of this innovative electronic control are described in the following description and drawings.

### BRIEF DESCRIPTION OF THE DRAWINGS

FIG. 1 shows the block diagram detailing the Control system is attached; and

FIG. 2 shows an updated at pre-established time periods.

### DETAILED DESCRIPTION OF THE INVENTION

The invention consists of an electronic control system that is integrable in drivers for led technology luminaires, with the following innovations:

An electronic control integrated within the same driver with functions for real-time geolocation and local time self-recognition of the LED luminaire, using GNSS, GPS or other geolocation technology, in conjunction with an integrated antenna to receive the information directly via satellite.

An optional integrated electronic light sensor available for use in areas where, in addition to local day/night time, other factors such as weather, fog, etc., require the luminaire to be switched on.

Implement a software with an intelligent algorithm inside the Micro Controller to perform the functions and decision making in an intelligent and autonomous way (without depending on a communication or remote control linked to any user or central), for switching on, dimming, switching off, location, date and time (recognizing geographical coordinates, time of the year and time).

Take advantage of existing technologies that the drivers have, to control lighting dimming levels by user-defined pre-programmed events at a real exact time according to the location, obtained via satellite (without the use of internal hour counters, which cause event mismatches, as a result of changes in the sunrise and sunset times in each season of the year). The time and date data used is obtained in real time from the satellite, without the intervention of any user or a data monitoring and control center.

The invention will give as an advantage, a simple installation of the luminaire using this unidirectional driver, without the intervention of any user, making it totally AUTONOMOUS, and very inexpensive in the medium and long term.

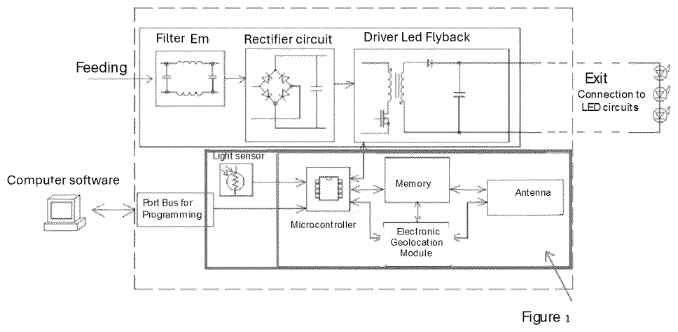

In the present application, the block diagram (FIG. 1) detailing the Control system is attached.

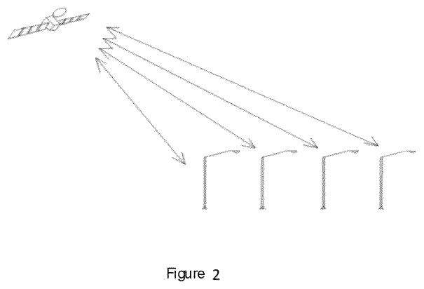

This complete device may be integrated with any drivers currently on the market, and will have application for the assembly of luminaires with LED technology, with a link to the open signal of a satellite network to keep time and location data updated every time the luminaire is turned on from the power line, or otherwise automatically updated at pre-established time periods (FIG. 2).

1. An electronic control system for public lighting with led lighting luminaires, the system comprising:
a real-time electronic geolocation module to link a via satellite using an integrated antenna to receive a real-time GNSS/GPS location and a local time information;
an antenna for linking to a satellite network, integrated within the device itself, a receiving time and a geographic position information in an open and an unidirectional way from the geolocation module;
a memory card to store a sunset and a sunrise times based on the geographical position, by using a non-volatile memory, which retains the information, even when the power supply is interrupted;
a micro controller that receives all the information from the electronic geolocation module with the antenna, from the memory, from the light sensor, and from a bus port, where data information is loaded by a user/manufacturer,
wherein the micro controller automatically sends commands to a LED Driver Circuit to perform the on/off/attenuation functions on time, and a corresponding real location data; and
a light sensor integrated or wired to an external part of the luminaire.
